(19) United States
(12) Patent Application Publication
(10) Pub. No.: US 2025/0119963 A1
(43) Pub. Date: Apr. 10, 2025

(54) PLURALITY OF BLUETOOTH CONTROLLERS WITH SINGLE PROTOCOL STACK

(71) Applicant: Cypress Semiconductor Corporation, San Jose, CA (US)

(72) Inventors: Ram Raja Kumar GEETHA VELUMAYIL STHANU, San Diego, CA (US); James BEGGS, Ramona, CA (US); Arvind SRIDHARAN, San Diego, CA (US); Manamohan MYSORE, Ramona, CA (US)

(73) Assignee: Cypress Semiconductor Corporation, San Jose, CA (US)

(21) Appl. No.: 18/649,276

(22) Filed: Apr. 29, 2024

Related U.S. Application Data
(60) Provisional application No. 63/588,275, filed on Oct. 5, 2023.

(51) Int. Cl. H04W 76/15; H04W 28/08; H04W 28/20; H04W 76/40

(52) U.S. Cl. CPC H04W 76/15; H04W 28/08; H04W 28/20; H04W 76/40

(57) ABSTRACT

A system includes a host and at least two Bluetooth controllers. The host is configured to execute a Bluetooth protocol stack. The at least two Bluetooth controllers are communicatively coupled to the host. Each Bluetooth controller is configured to wirelessly communicate with at least one respective external device.

### RELATED APPLICATION(S)

This application claims priority to U.S. Provisional 63/588,275 filed on Oct. 5, 2023 the entirety of which is hereby incorporated by reference herein.

### BACKGROUND

There are scenarios in which multiple peripheral devices are connected to a host Bluetooth device, such as an infotainment system. The multiple peripheral devices could include, for example, gaming audio devices (e.g., headphones), voice chat devices (e.g., headphones, microphones), game controller devices, multi-stream audio playback devices, low latency karaoke devices, remote control devices, etc. With multiple connected devices, the Bluetooth controller of the host Bluetooth device might not be able to service all requested features of the multiple connected devices and the higher bandwidth that may be required by the multiple connected devices at the same time. For these and other reasons, a need exists for the claimed subject matter.

### SUMMARY

Some examples of the present disclosure relate to a system. The system includes a host and at least two Bluetooth controllers. The host is configured to execute a Bluetooth protocol stack. The at least two Bluetooth controllers are communicatively coupled to the host. Each Bluetooth controller is configured to wirelessly communicate with at least one respective external device

Other examples of the present disclosure relate to a system. The system includes a host and a plurality of Bluetooth controllers. The host is configured to execute an application and a Bluetooth protocol stack. The host comprises a multi-controller abstraction layer. The plurality of Bluetooth controllers are communicatively coupled to the host. Each Bluetooth controller is configured to wirelessly communicate with at least one respective external device. The multi-controller abstraction layer is configured to present the plurality of Bluetooth controllers to the Bluetooth protocol stack as a single Bluetooth controller.

Yet other examples of the present disclosure relate to a method. The method includes receiving a request to connect an external device to a Bluetooth system comprising a host executing a Bluetooth protocol stack. The method includes connecting the external device to a first Bluetooth controller of a plurality of Bluetooth controllers communicatively coupled to the host based on an expected bandwidth level for the external device.

### BRIEF DESCRIPTION OF THE DRAWINGS

FIG. 1A is a block diagram illustrating an example system including a host and at least two Bluetooth controllers.

FIG. 1B is a block diagram illustrating another example system including a host and at least two Bluetooth controllers.

FIG. 2 is a block diagram illustrating an example Bluetooth controller.

FIG. 3 is a block diagram illustrating an example Bluetooth controller acting as a server with the remaining Bluetooth controllers acting as clients.

FIG. 4 is a flow diagram illustrating an example method for load balancing.

FIGS. 5A-5C are flow diagrams illustrating an example method for a passive transfer connection handoff.

FIGS. 6A and 6B are flow diagrams illustrating a first stage and a second stage of another example method for a passive transfer connection handoff.

FIGS. 7A and 7B are flow diagrams illustrating a first stage and a second stage of another example method for a passive transfer connection handoff.

FIGS. 8A and 8B are flow diagrams illustrating a third stage and a fourth stage of the example method of FIGS. 6A and 6B or the example method of FIGS. 7A and 7B.

FIGS. 9A-9C are flow diagrams illustrating an example method for an active transfer connection handoff.

FIG. 10 is a block diagram illustrating an example system including a host and at least two Bluetooth controllers.

FIGS. 11A and 11B are flow diagrams illustrating example methods for controlling the flow of packets between a host and at least two Bluetooth controllers.

FIG. 12 is a flow diagram illustrating an example method for load balancing.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

An infotainment unit, such as a vehicle infotainment unit, may connect via Bluetooth to headphones, mobile phones, game controllers, microphones, remotes, and/or other devices. For example, the vehicle infotainment unit may simultaneously support a co-op gaming application including two users each with a connected gaming controller and headphones for gaming audio and voice chat, mobile phone streaming audio or call control, an infotainment remote, and a microphone for phone call, voice chat, or karaoke. When multiple Bluetooth controllers and respective host stacks are used, pairing and connection procedures could require manual intervention for balancing the load and connections may disrupt the user experience. When a single Bluetooth controller and host stack is used, the requested features or bandwidth may be compromised and/or the Bluetooth controller may report to the host that it cannot support a request and may drop the connection.

Accordingly, disclosed herein is a Bluetooth unit/node with a plurality (e.g., at least two) Bluetooth controllers connected to a single host running a Bluetooth protocol stack. In this way, the Bluetooth unit/node is capable of effectively handling the demand from simultaneous connections from multiple sources.

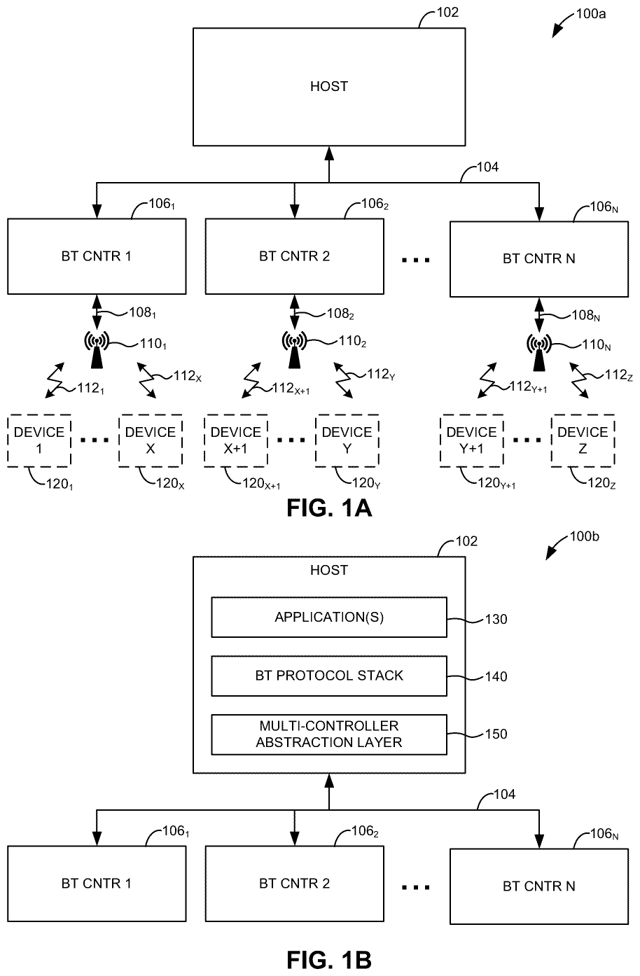

FIG. 1A is a block diagram illustrating an example system 100a. System 100a includes a host 102, at least two Bluetooth controllers 106₁ to 106_{N}, where “N” is any suitable number of Bluetooth controllers (e.g., 2, 3, 4, 5, 6, 7, 8, or more), and a plurality of external (e.g., peripheral) devices 120₁ to 120_{Z}. Host 102 is communicatively coupled to each Bluetooth controller 106₁ to 106_{N} through a communication path 104. Each Bluetooth controller 106₁ to 106_{N} is communicatively coupled to an antenna circuit 110₁ to 110_{N} through a communication path 108₁ to 108_{N}, respectively. Antenna circuits 110₁ to 110_{N} may be communicatively coupled to a plurality of external devices 120₁ to 120_{Z}. For example, antenna circuit 110₁ may be communicatively coupled to external devices 120₁ to 120_{X} through wireless communication paths 112₁ to 112_{X}, respectively, where “X” is any suitable number of external devices (e.g., 1, 2, 3, 4, 5, 6, or more). Antenna circuit 1102 may be communicatively coupled to external devices 120_{X+1} to 120_{Y} through wireless communication paths 112ₓ₊₁ to 112_{Y}, respectively, where “Y” is any suitable number of additional external devices greater than X, (e.g., an additional 1, 2, 3, 4, 5, 6, or more devices). Likewise, antenna circuit 110_{N} may be communicatively coupled to external devices 120_{Y+1} to 120_{Z} through wireless communication paths 112_{Y+1} to 112_{Z}, respectively, where “Z” is any suitable number of additional external devices greater than Y, (e.g., an additional 1, 2, 3, 4, 5, 6, or more devices). Accordingly, host 102 may be communicatively coupled to a plurality of external devices 120₁ to 120_{Z} through the at least two Bluetooth controllers 106₁ to 106_{N} to enable multiple connected devices while servicing all requested features of the multiple connected devices and providing the higher bandwidth of the multiple connected devices at the same time.

In at least the following FIGS. 1B, 2, 3, and 10, antenna circuits 110₁ to 110_{N} and external devices 120₁ to 120_{Z} are excluded from the figures for simplicity, but it will be apparent that each Bluetooth controller 106₁ to 106_{N} includes or is communicatively coupled to an antenna circuit 110₁ to 110_{N} for wirelessly communicating with one or more external devices.

FIG. 1B is a block diagram illustrating another example system 100b including a host 102 and at least two Bluetooth controllers 106₁ to 106_{N}. Host 102 includes application(s) 130, a Bluetooth protocol stack 140, and a multi-controller abstraction layer 150. In some examples, host 102 and each Bluetooth controller 106₁ to 106_{N} may be integrated into a single semiconductor chip. In other examples, host 102 and each Bluetooth controller 106₁ to 106_{N} may be integrated into different semiconductor chips.

Application(s) 130 includes one or more applications that may connect to external devices 120₁ to 120_{Z} to send and/or receive data. For example, application(s) 130 may include one or more of a music streaming application, a voice chat application, a phone call control and/or phone audio streaming application, a gaming application, an infotainment remote application, etc. Bluetooth protocol stack 140 is a layered architecture, with each layer providing a specific set of functionality. Bluetooth protocol stack 140 acts as an interface between Bluetooth controllers 106₁ to 106_{N} and application(s) 130.

Multi-controller abstraction layer 150 is configured to present the at least two Bluetooth controllers 106₁ to 106_{N} to the Bluetooth protocol stack 140 as a single Bluetooth controller. Multi-controller abstraction layer 150 may share and manage the active load of external devices 120₁ to 120_{Z} (FIG. 1A) among the Bluetooth controllers 106₁ to 106_{N} by implementing a load balancing process. As further described below, the load balancing process may include implementing a continuous profiling/feedback mechanism to optimize handoff and load balancing among the Bluetooth controllers 106₁ to 106_{N}.

Each Bluetooth controller 106₁ to 106_{N} may include a controller support layer to enable handoff and load balancing among the Bluetooth controllers 106₁ to 106_{N}. The controller support layer may implement a clock synchronization service and connection handoff mechanism to transfer connections of external devices 120₁ to 120_{Z} (FIG. 1A) between the Bluetooth controllers 106₁ to 106_{N}. All the Bluetooth controllers 106₁ to 106_{N} use the same Bluetooth address to communicate with the external devices 120₁ to 120_{Z} of FIG. 1A. In this way, each external device 120₁ to 120_{Z} will see host 102 and Bluetooth controllers 106₁ to 106_{N} as a single Bluetooth unit/node.

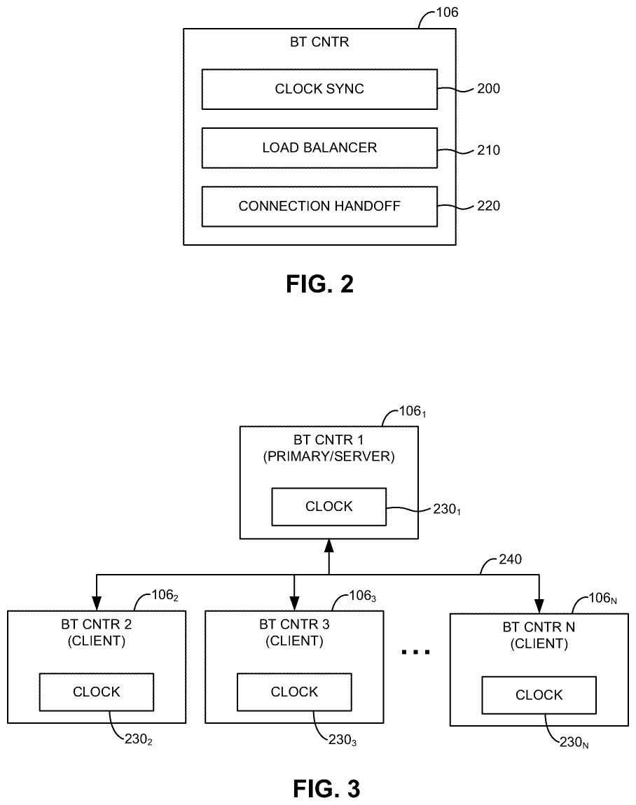

FIG. 2 is a block diagram illustrating an example Bluetooth controller 106. Bluetooth controller 106 may provide each Bluetooth controller 106₁ to 106_{N} of FIGS. 1A and 1B. Bluetooth controller 106 may include a clock synchronization service 200, a load balancing service 210, and a connection handoff service 220 in addition to the Bluetooth functionalities and services provided by the Bluetooth controller. As will be further described below, clock synchronization service 200 synchronizes the clocks of each of the at least two Bluetooth controllers 106₁ to 106_{N} (FIGS. 1A and 1B) with each other. Load balancing service 210 tracks the runtime load of the Bluetooth controller 106 and may make decisions based on the runtime loading of the Bluetooth controller 106. Connection handoff service 220 transfers connections between the Bluetooth controller 106 and other Bluetooth controllers.

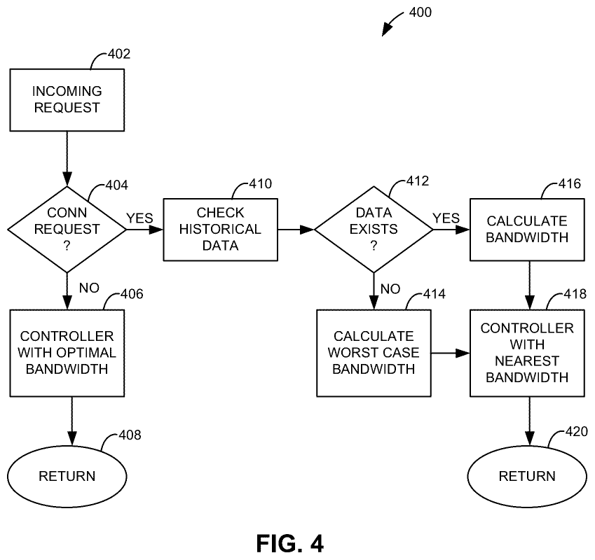

FIG. 3 is a block diagram illustrating an example Bluetooth controller 106₁ acting as a primary/server with the remaining Bluetooth controllers 106₂ to 106_{N} acting as clients. While Bluetooth controller 106₁ is illustrated as the primary/server in this example, in other examples, any of Bluetooth controllers 106₂ to 106_{N} may act as the primary/server with the remaining Bluetooth controllers, including Bluetooth controller 106₁, acting as clients. Primary/server Bluetooth controller 106₁ is communicatively coupled to each client Bluetooth controller 106₂ to 106_{N} through a communication path 240. Each Bluetooth controller 106₁ to 106_{N} includes a clock 230₁ to 230_{N}, respectively.

The clock synchronization service 200 (FIG. 2) of Bluetooth controller 106₁ periodically synchronizes the clocks 230₂ to 230_{N} of Bluetooth controllers 106₂ to 106_{N} with clock 230₁ of the primary Bluetooth controller 106₁. For example, the clock synchronization may run every 300 milliseconds, every 500 milliseconds, or every 1 second. There are multiple ways to synchronize the clocks in the distributed system of FIG. 3, such as Bluetooth Low Energy (LE) advertisement/LE scan, periodic advertisement/periodic sync, establishing a LE connection, and/or input/output (I/O) based or wired communication protocols. In this example, the periodic advertising and periodic sync feature provided by Bluetooth Low Energy is used to periodically synchronize the clocks 230₂ to 230_{N} of the Bluetooth controllers 106₂ to 106_{N} with the clock 230₁ of the primary Bluetooth controller 106₁ by transmitting a periodic advertisement to each client Bluetooth controller 106₂ to 106_{N} at regular intervals.

The packet structure of the periodic advertisement may be customized to include the primary Bluetooth controller 106₁ clock 230₁ information, an event counter, and controller state information. The event counter may be incremented for each transmission of the periodic advertisement. The event counter may be used by a client Bluetooth controller 106₂ to 106_{N} to calculate timing even if the client misses a packet. The primary Bluetooth controller 106₁ clock 230₁ information may include the current clock 230₁ information and Bluetooth slots-based clock counter. The controller state information may include accumulated state information of the primary Bluetooth controller 106₁ and the client Bluetooth controllers 106₂ to 106_{N}. The client Bluetooth controllers 106₂ to 106_{N} synchronize to the periodic advertisement and fine tune their clocks 230₂ to 230_{N}, respectively, with hardware support or maintain the primary Bluetooth controller 106₁ clock 230₁ information continuously. All timing information (e.g., for handoff) is shared relative to the primary Bluetooth controller 106₁ clock 230₁.

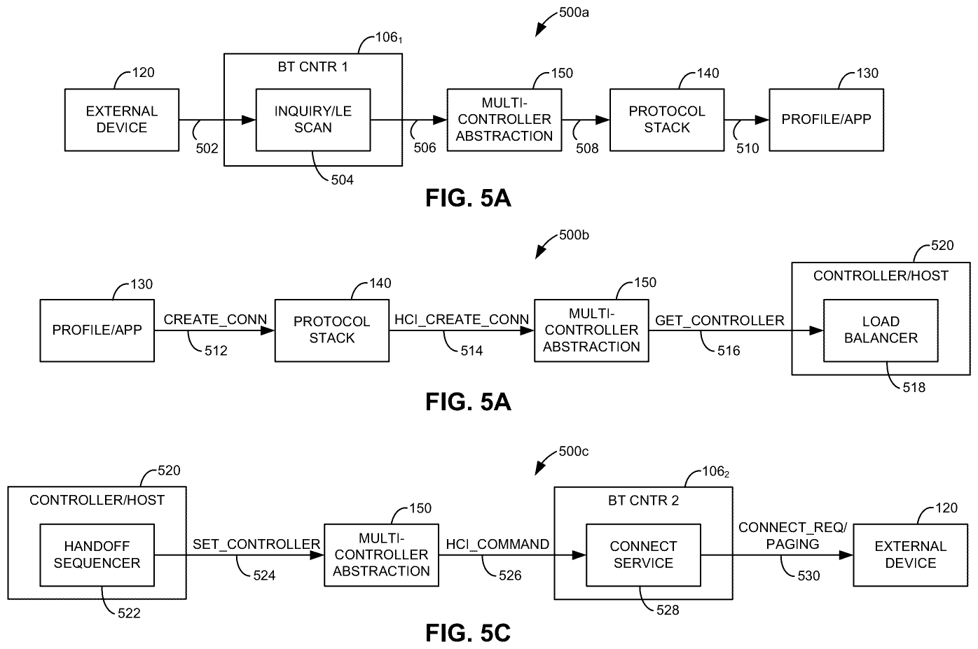

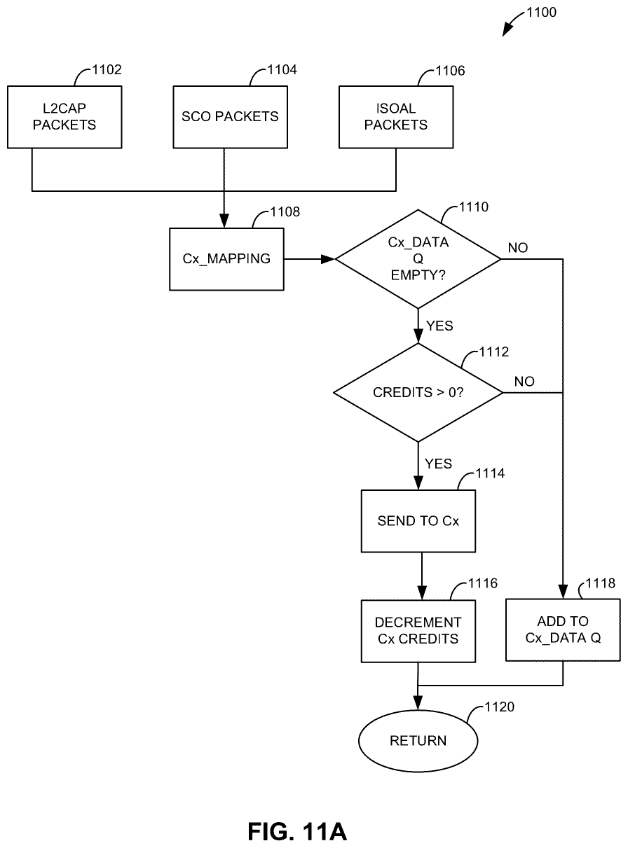

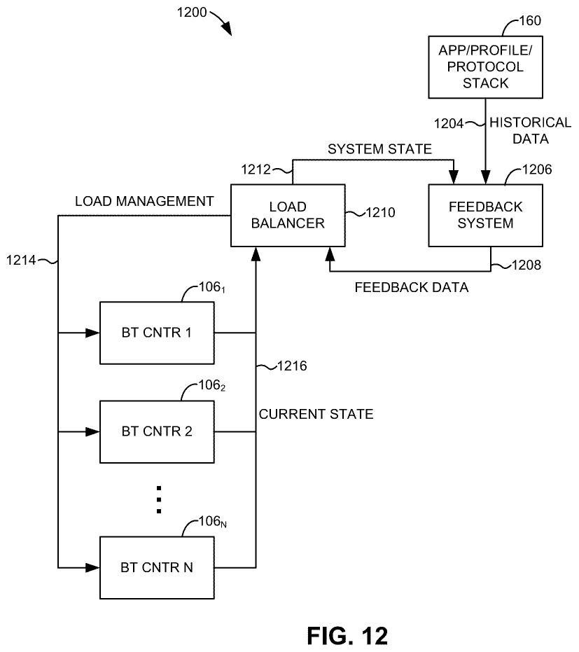

FIG. 4 is a flow diagram illustrating an example method 400 for load balancing. In some examples, a load balancing service may be part of a Bluetooth controller (e.g., load balancer 210 of FIG. 2) and/or part of multi-controller abstraction layer 150 (e.g., load balancer 174 of FIG. 10 described below). The load balancer may analyze the current state (e.g., loading) of the system and feedback from historical data (which will be further described with reference to FIG. 12) provided by multi-controller abstraction layer 150 (FIG. 1B) to decide where to place external device 120₁ to 120_{Z} connections or to transfer active external device 120₁ to 120_{Z} connections among Bluetooth controllers 106₁ to 106_{N}.

The load balancer may be implemented using different approaches. One approach is implementing the load balancer within a Bluetooth controller 106₁ to 106_{N}, which acts as the primary/server (e.g., 106₁ of FIG. 3) in the group of Bluetooth controllers and sends the commands/data to other Bluetooth controllers through a communication interface. Another approach is implementing the load balancer within the multi-controller abstraction layer 150 (FIG. 1B), which analyzes all the information provided by the Bluetooth controllers 106₁ to 106_{N} and makes decisions based on the provided information. Yet another approach is implementing the load balancer in a decentralized way where each Bluetooth controller 106₁ to 106_{N} executes load balancer logic and negotiates with the other Bluetooth controllers in the system for load sharing.

Parameters that may be used as input to the load balancing decisions include bandwidth occupancy in each Bluetooth controller 106₁ to 106_{N} and feedback input from multi-controller abstraction layer 150. The bandwidth occupancy in each Bluetooth controller 106₁ to 106_{N} may be determined via a Link Resource Manager (LRM) that maintains the active bandwidth usage in the Bluetooth controller, connection and scan intervals and throughput/bandwidth levels for them, and/or a maximum number of connections and/or a memory usage limit.

As illustrated in FIG. 4 at 402, method 400 includes receiving an incoming request. The incoming request may be provided by the host (e.g., from an application 130 of FIG. 1B) or from an external device (e.g., 120₁ to 120_{Z} of FIG. 1A). At 404, method 400 determines whether the request is a connection request. If the request is not a connection request, then at 406 method 400 determines the Bluetooth controller with the optimal bandwidth and returns the selected Bluetooth controller at 408. The incoming request is then sent to the selected Bluetooth controller. In some examples, the Bluetooth controller with optimal bandwidth selected at 406 may result in a handoff sequence, which adds flexibility to transfer a new connection allowing scan or advertising operations with minimal bandwidth.

If the request is a connection request, then at 410 method 400 checks historical data for the external device to be connected. At 412, method 400 determines whether historical data exists for the external device to be connected. If no historical data exists for the external device to be connected, then at 414 method 400 calculates the worst case bandwidth level for the external device to be connected. The worst case bandwidth level may consider LE Isochronous Channels (LE ISoC) or Advanced Audio Distribution Profile (A2DP) plus Hands-Free Profile (HFP) as the worst case bandwidth level for the device to be connected. If historical data exists for the external device to be connected, then at 416, method 400 calculates the bandwidth level for the external device based on the historical data for the external device. In either case, at 418 method 400 selects the Bluetooth controller with the nearest available bandwidth to the calculated bandwidth from 414 or 416 and returns the selected Bluetooth controller at 420. The connection request is then sent to the selected Bluetooth controller.

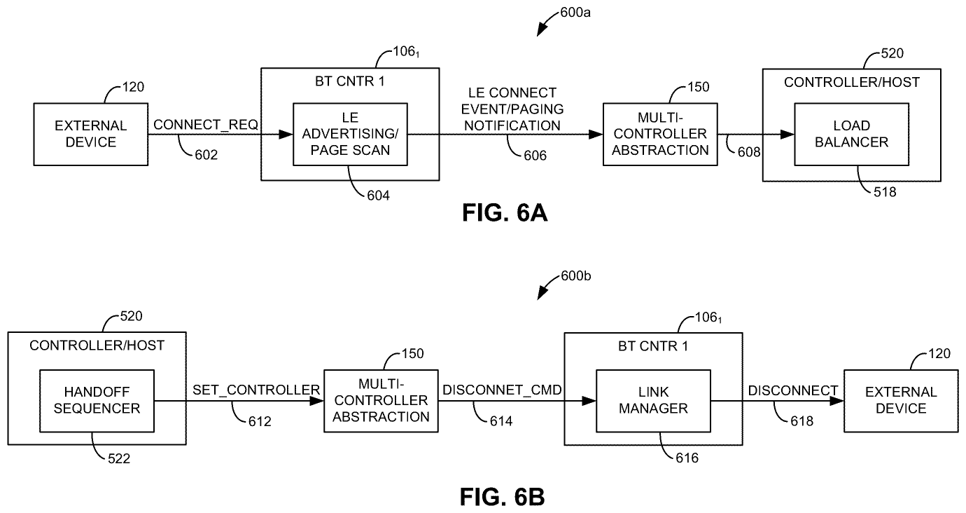

For an external device connection handoff, clocks of the Bluetooth controllers 106₁ to 106_{N} are synchronized as previously described with reference to FIG. 3. The synchronized clocks are used to calculate the timing of a connection handoff in both the Bluetooth controller handing off a connection and the Bluetooth controller resuming the connection. To handoff a connection, the Bluetooth controllers exchange a data blob (Binary Large Object) to share the current context of the connection. A communication interface between the Bluetooth controllers is used to synchronize the clocks and to exchange the data blob. The communication interface may be a wireless sync, a wired connection between the Bluetooth controllers, or through a Host Controller Interface (HCI) multiplexer unit. For resuming connections at another Bluetooth controller, the clock synchronization is used to tune the timing for matching with the connection. The load balancer determines to which Bluetooth controller within the same node a connection should be handed off. The load balancer triggers the transfer using either a passive or an active/live transfer sequence as described below with reference to FIGS. 5A-9C.

FIGS. 5A-5C are flow diagrams illustrating an example method for a passive transfer connection handoff where the connection request comes from the host. In a passive transfer connection handoff, a pending connection is transferred to another Bluetooth controller prior to establishing the connection between the Bluetooth controller and the external device. FIGS. 5A-5C illustrate a passive transfer connection handoff for primary/central roles in Basic Rate (BR)/Enhanced Data Rate (EDR) (e.g., paging) and Bluetooth Low Energy (BLE) (e.g., LE scan/initiator).

FIG. 5A illustrates a first stage (e.g., stage 1) 500a of a passive transfer connection handoff. Stage 1 involves external device discovery. As shown in FIG. 5A, an external device 120 may be discovered as indicated at 502 in response to an inquiry or LE scan as indicated at 504 from Bluetooth controller 106₁ (which may be acting as a primary Bluetooth controller). The inquiry/LE scan result is passed from Bluetooth controller 106₁ to multi-controller abstraction layer 150 as indicated at 506. The inquiry/LE scan result is passed from the multi-controller abstraction layer 150 to the Bluetooth protocol stack 140 as indicated at 508. The inquiry/LE scan result is passed from the Bluetooth protocol stack 140 to the profile/application 130 as indicated at 510. In this way, the profile/application 130 discovers the external device 120.

FIG. 5B illustrates a second stage (e.g., stage 2) 500b of the passive transfer connection handoff. Stage 2 involves a paging/LE connection request and load balancing. As shown in FIG. 5B, in response to the profile/application 130 desiring to connect to external device 120, the profile/application 130 sends a create connection (CREATE_CONN) command to the Bluetooth protocol stack 140 as indicated at 512. In response to the create connection command, the Bluetooth protocol stack 140 sends a HCI create connection (HCI_CREATE_CONN) command to the multi-controller abstraction layer 150 as indicated at 514. In response to the HCI create connection command, the multi-controller abstraction layer 150 sends a get controller (GET_CONTROLLER) command to a load balancer 518 of a controller/host 520 as indicated at 516. In some examples, load balancer 518 may be load balancer 210 (FIG. 2) and controller/host 520 may be a Bluetooth controller 106, (such as primary Bluetooth controller 106₁ of FIG. 3). In some examples, load balancer 518 may be part of multi-controller abstraction layer 150 (e.g., 174 in FIG. 10) and controller/host 520 may be host 102 (FIG. 1B). In any case, in response to the get controller command, load balancer 518 determines which Bluetooth controller external device 120 should be connected to based on a calculated bandwidth level for the external device 120 as previously described and illustrated with reference to FIG. 4. In this example, load balancer 518 selects Bluetooth controller 106₂.

FIG. 5C illustrates a third stage (e.g., stage 3) 500c of the passive transfer connection handoff. Stage 3 involves a handoff sequencer and connection establishment. As shown in FIG. 5C, a handoff sequencer 522 of the controller/host 520 sends a set controller (SET_CONTROLLER) command to multi-controller abstraction layer 150 as indicated at 524. In response to the set controller command, multi-controller abstraction layer 150 sends a HCI command (HCI_COMMAND) to a connect service 528 (e.g., of connection handoff service 220 of FIG. 2) of Bluetooth controller 106₂ as indicated at 526. In response to the HCI command, connect service 528 of Bluetooth controller 106₂ sends a connection request/paging (CONNECT_REQ/PAGING) to external device 120 as indicated at 530 to establish the connection between external device 120 and Bluetooth controller 106₂.

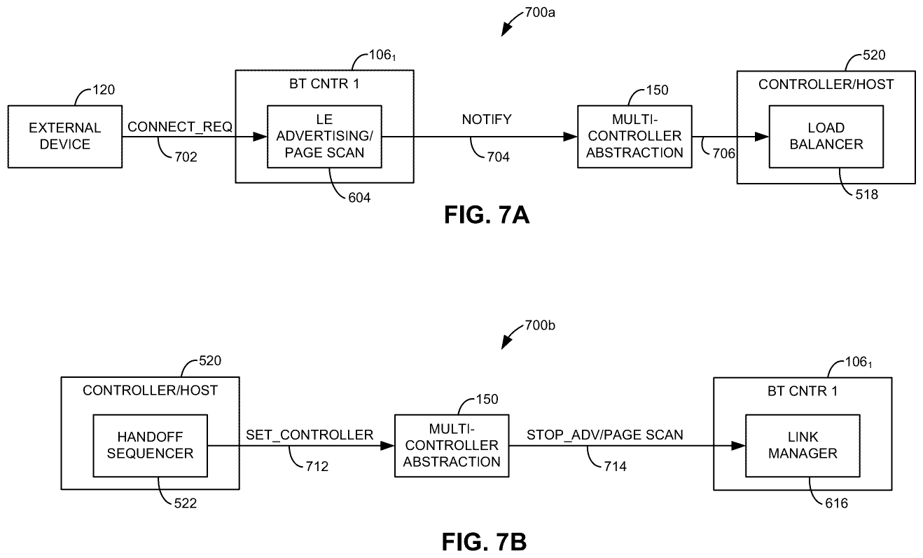

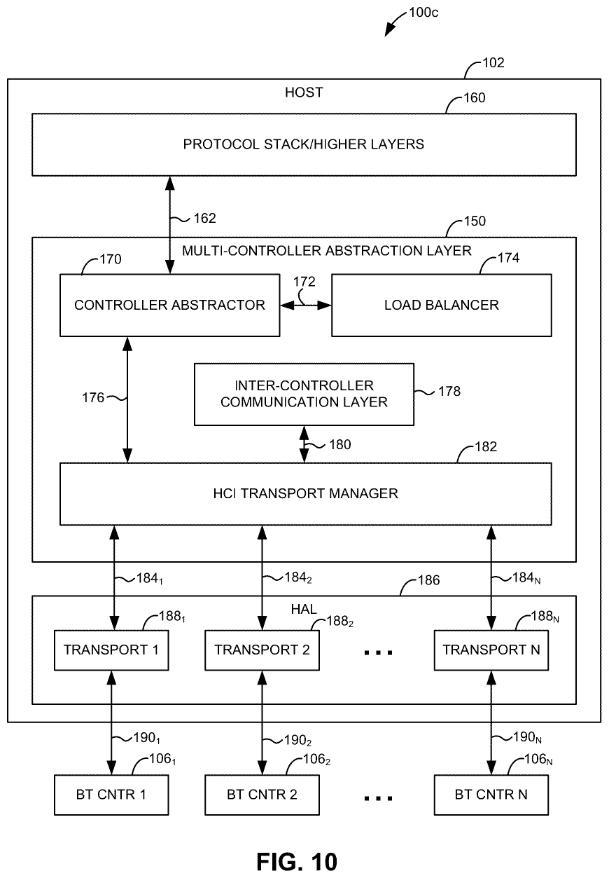

For peripheral external device roles in BR/EDR and BLE, a connection request from an external device could be handled in one of two ways for passive transfer. A first way includes entering the connection with a requested external device and notifying the load balancer of the connection. In this case, if a transfer is desired, the connection is disconnected and then reconnected to the selected Bluetooth controller when the external device retries to connect. A second way includes not accepting the connection and notifying the load balancer. In this case, after the load balancer selects a Bluetooth controller, the selected Bluetooth controller connects with the external device when the external device retries to connect. Stages 1 and 2 differ for the above two methods while stages 3 and 4 are common to them as illustrated in the following FIGS. 6A-8B. Contention may be an issue if a second external device tries to connect at the same time when a sequence is in progress to connect with a first external device. In this case, an active transfer procedure as illustrated in the following FIGS. 9A-9C may be used to address this issue.

FIGS. 6A and 6B are flow diagrams illustrating a first stage and a second stage of an example method for a passive transfer connection handoff when the connection request comes from an external device. FIG. 6A illustrates a first stage (e.g., stage 1) 600a of a passive transfer connection handoff. Stage 1 involves a connection request from an external device. As shown in FIG. 6A, an external device 120 sends a connection request (CONNECT_REQ) to Bluetooth controller 106₁ (which may be acting as the primary Bluetooth controller) as indicated at 602 in response to an LE advertisement/page scan 604 of Bluetooth controller 106₁. In response to the connection request, Bluetooth controller 106₁ sends an LE connect evet/paging notification to multi-controller abstraction layer 150 as indicated at 606. In response to the LE connect event/paging notification, multi-controller abstraction layer 150 sends a request to load balancer 518 of controller/host 520 as indicated at 608. Load balancer 518 then selects to which Bluetooth controller external device 120 will connect. In this example, load balancer 518 selects Bluetooth controller 106₂.

FIG. 6B illustrates a second stage (e.g., stage 2) 600b of the passive transfer connection handoff. Stage 2 involves a handoff sequencer triggered when the load balancer decides to transfer the connection. As shown in FIG. 6B, handoff sequencer 522 of controller/host 520 sends a set controller (SET_CONTROLLER) command to multi-controller abstraction layer 150 as indicated at 612. In response to the set controller command, multi-controller abstraction layer 150 sends a disconnect command (DISCONNECT_CMD) to a link manager 616 of Bluetooth controller 106₁ as indicated at 614. In response to the disconnect command, link manager 616 of Bluetooth controller 106₁ disconnects the external device 120 as indicated at 618.

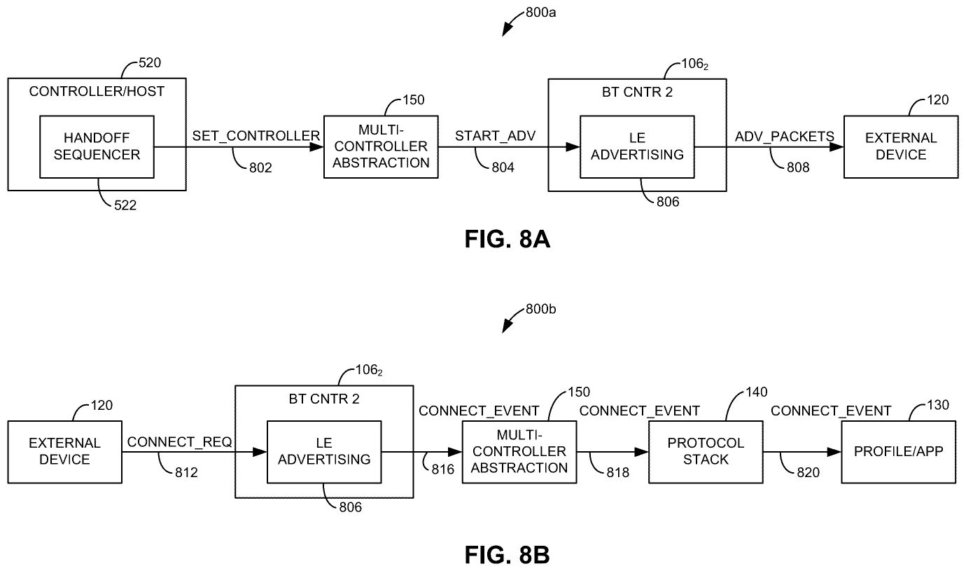

FIGS. 7A and 7B are flow diagrams illustrating a first stage and a second stage of another example method for a passive transfer connection handoff when the connection request comes from an external device. FIG. 7A illustrates a first stage (e.g., stage 1) 700a of a passive transfer connection handoff. Stage 1 involves a connection request from an external device. As shown in FIG. 7A, an external device 120 sends a connection request (CONNECT_REQ) to Bluetooth controller 106₁ (which may be acting as the primary Bluetooth controller) as indicated at 702 in response to an LE advertisement/page scan 604 of Bluetooth controller 106₁. In response to the connection request, Bluetooth controller 106₁ notifies multi-controller abstraction layer 150 of the connection request as indicated at 704. In response to the notification, multi-controller abstraction layer 150 sends a request to load balancer 518 of controller/host 520 as indicated at 706. Load balancer 518 then selects to which Bluetooth controller (if needed) external device 120 will be handed off. In this example, load balancer 518 selects Bluetooth controller 106₂.

FIG. 7B illustrates a second stage (e.g., stage 2) 700b of the passive transfer connection handoff. Stage 2 involves a handoff sequencer triggered when the load balancer decides to transfer the connection. As shown in FIG. 7B, handoff sequencer 522 of controller/host 520 sends a set controller (SET_CONTROLLER) command to multi-controller abstraction layer 150 as indicated at 712. In response to the set controller command, multi-controller abstraction layer 150 sends a stop advertising/page scan (STOP_ADV/PAGE SCAN) to a link manager 616 of Bluetooth controller 106₁ as indicated at 714.

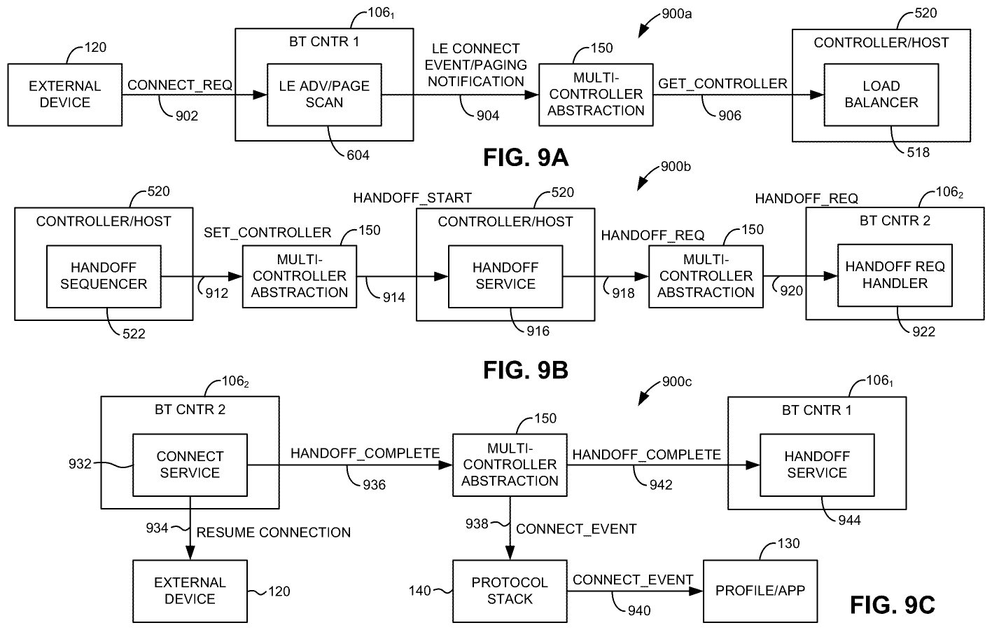

FIGS. 8A and 8B are flow diagrams illustrating a third stage and a fourth stage of the example passive transfer connection handoff methods of FIGS. 6A and 6B and FIGS. 7A and 7B. FIG. 8A illustrates a third stage (e.g., stage 3) 800a of a passive transfer connection handoff. Stage 3 involves a handoff sequencer that notifies Bluetooth controller 106₂ to take over the connection. As shown in FIG. 8A, handoff sequencer 522 of controller/host 520 sends a set controller (SET_CONTROLLER) command to multi-controller abstraction layer 150 as indicated at 802. In response to the set controller command, multi-controller abstraction layer 150 sends a start advertising (START_ADV) command to an LE advertising service 806 of Bluetooth controller 106₂ as indicated at 804. In response to the start advertising command, LE advertising service 806 of Bluetooth controller 106₂ sends advertising packets (ADV_PACKETS) to external device 120 as indicated at 808.

FIG. 8B illustrates a fourth stage (e.g., stage 4) 800b of the passive transfer connection handoff. Stage 4 involves Bluetooth controller 106₂ establishing a connection with the external device. As shown in FIG. 8B, external device 120 sends a connection request (CONNECT_REQ) to Bluetooth controller 106₂ in response to the advertising packets from LE advertising service 806 as indicated at 812. In response to the connection request, Bluetooth controller 106₂ sends a connect event (CONNECT_EVENT) to multi-controller abstraction layer 150 as indicated at 816. In response to the connect event, multi-controller abstraction layer 150 sends a connect event to protocol stack 140 as indicated at 818. In response to the connect event, protocol stack 140 sends a connect event to profile/application 130 as indicated at 820 to complete the connection to external device 120.

An active/live transfer connection handoff uses the clock synchronization service to transfer timing references to other Bluetooth controllers. Active/live transfer may be used when reconnecting or passive handoff is not preferred in the system. In one example of an active/live transfer, a first Bluetooth controller establishes a connection with an external device, holds the connection in an active state, and notifies a second Bluetooth controller of the timing and connection information to resume the connection. Both the first and second Bluetooth controllers agree to a specific point T where the second Bluetooth controller will take full control of the external device from the first Bluetooth controller, which is calculated in reference to the active connection timing. The first Bluetooth controller then stops the link management at time T and the second Bluetooth controller resumes the connection at time T to complete the active/live transfer.

FIGS. 9A-9C are flow diagrams illustrating an example method for an active transfer connection handoff. FIG. 9A illustrates a first stage (e.g., stage 1) 900a of an active transfer connection handoff. Stage 1 involves an external device sending a connection request. As shown in FIG. 9A, external device 120 sends a connection request (CONNECT_REQ) to Bluetooth controller 106₁ in response to LE advertisement/page scan 604 as indicated at 902. In response to the connection request, Bluetooth controller 106₁ sends a LE connect event/paging notification to multi-controller abstraction layer 150 as indicated at 904. In response to the LE connect event/paging notification, multi-controller abstraction layer 150 sends a get controller command to load balancer 518 of controller/host 520 as indicated at 906. Load balancer 518 then selects to which Bluetooth controller (if needed) external device 120 will be handed off. In this example, load balancer 518 selects Bluetooth controller 106₂.

FIG. 9B illustrates a second stage (e.g., stage 2) 900b of the active transfer connection handoff. Stage 2 involves a handoff sequencer. As shown in FIG. 9B, handoff sequencer 522 of controller/host 520 sends a set controller command to multi-controller abstraction layer 150 as indicated at 912. In response to the set controller command, multi-controller abstraction layer 150 sends a handoff start (HANDOFF_START) request to a handoff service 916 of controller/host 520 as indicated at 914. Handoff service 916 pauses and holds the active connection between Bluetooth controller 106₁ and external device 120 without data transactions and without dropping the connection. In response to the handoff start request, handoff service 916 of controller/host 520 sends a handoff request (HANDOFF_REQ) to multi-controller abstraction layer 150 as indicated at 918. In response to the handoff request, multi-controller abstraction layer 150 sends a handoff request to a handoff request handler 922 of Bluetooth controller 106₂ as indicated at 920.

FIG. 9C illustrates a third stage (e.g., stage 3) 900c of the active transfer connection handoff. Stage 3 involves resuming the connection. As shown in FIG. 9C, a connect service 932 (e.g., as part of connection handoff service 220 of FIG. 2) of Bluetooth controller 106₂ resumes the connection to external device 120 as indicated at 934 and sends a handoff complete notification to multi-controller abstraction layer 150 as indicated at 936. In response to the handoff complete notification, multi-controller abstraction layer 150 sends a connect event to protocol stack 140 as indicated at 938 and a handoff complete notification to a handoff service 944 (e.g., as part of connection handoff service 220 of FIG. 2) of Bluetooth controller 106₁. In response to the connect event, protocol stack 140 sends a connect event to profile/app 130 to complete the active transfer connection handoff.

FIG. 10 is a block diagram illustrating an example system 100c. System 100c includes a host 102 and a plurality of (e.g., at least two) Bluetooth controllers 106₁ to 106_{N}. Host 102 includes a multi-controller abstraction layer 150, a protocol stack/higher layers 160, and a Hardware Abstraction Layer (HAL) 186. Protocol stack/higher layers 160 may include application 130 and Bluetooth protocol stack 140 as previously described and illustrated with reference to FIG. 1B. Multi-controller abstraction layer 150 may include a controller abstractor 170, a load balancer 174, an inter-controller communication layer 178, and a Host Controller Interface (HCI) transport manager 182. HAL 186 may include transports 188₁ to 188_{N}.

Protocol stack/higher layers 160 are communicatively coupled to controller abstractor 170 through a communication path 162. Controller abstractor 170 is communicatively coupled to load balancer 174 through a communication path 172 and to HCI transport manager 182 through a communication path 176. HCI transport manager 182 is communicatively coupled to inter-controller communication layer 178 through a communication path 180 and to transports 188₁ to 188_{N} through communication paths 184₁ to 184_{N}, respectively. Each transport 188₁ to 188_{N} is communicatively coupled to a Bluetooth controller 106₁ to 106_{N} through a communication path 190₁ to 190_{N}, respectively.

As will be further described below, controller abstractor 170 of multi-controller abstraction layer 150 presents the plurality of Bluetooth controllers 106₁ to 106_{N} to the protocol stack/higher layers 160 as a single Bluetooth controller. HCI transport manager 182 multiplexes HCI transport layers into a single transport layer to the controller abstractor 170. Inter-controller communication layer 178 supports the passing of messages between the plurality of Bluetooth controllers 106₁ to 106_{N}. A host interface sends and receives packets to and from protocol stack/higher layers 160. HCI transport manager 182 handles all HAL layers for HCI transport. Transports 188₁ to 188_{N} may include any suitable communication layer, such as Universal Asynchronous Receiver/Transmitter (UART), Secure Digital Input Output (SDIO), Peripheral Component Interconnect express (PCIe), or a custom transport protocol carrying HCI packets.

Controller abstractor 170 manages the mapping of active Bluetooth operations in each Bluetooth controller 106₁ to 106_{N}. Controller abstractor 170 also maintains and distributes data other than bandwidth or device profiles to other Bluetooth controllers 106₁ to 106_{N} to avoid conflicts and/or collisions for improved airtime management, such as connection handles, access address, Adaptive Frequency Hopping (AFH), channel, and coexistence information.

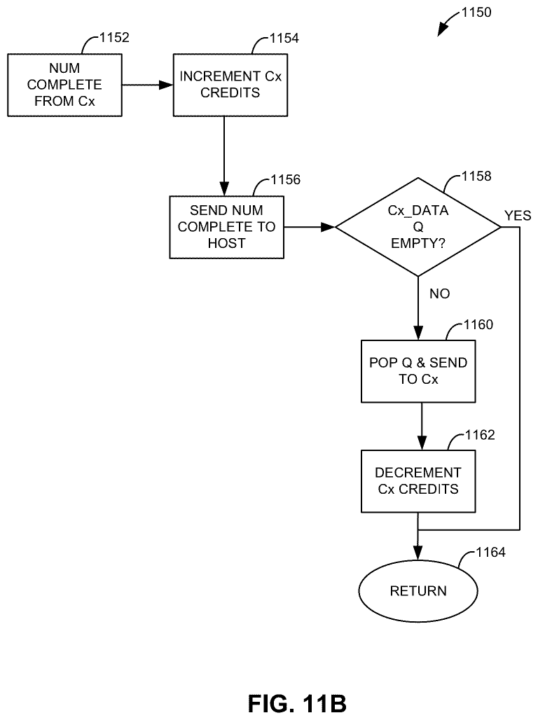

In some examples, load balancer 174 has two roles. A first role is identifying and prioritizing data paths as handling multiple transports could become a bottleneck in the system. Priority queues may be used to ensure target quality of service levels are met as further described below with reference to FIGS. 11A and 11B. A second role is connection and airtime management. The connection and airtime management logic may be implemented in a primary Bluetooth controller (e.g., 106₁ of FIG. 3) or in load balancer 174 of multi-controller abstraction layer 150.

Controller abstractor 170 sends and receives packets to and from protocol stack/higher layers 160. Controller abstractor 170 initializes all the Bluetooth controllers 106₁ to 106_{N}. Controller abstractor 170 implements a HCI command, event, and data listener service between the host and lower layers. Controller abstractor 170 interfaces with the load balancer 174 to manage the load distribution information for Bluetooth controllers 106₁ to 106_{N}. Controller abstractor 170 maintains a lookup table to map Bluetooth controllers 106₁ to 106_{N} to active connection handles in a Bluetooth connection. This lookup table is used to direct the packets to intended controller transports 188₁ to 188_{N} via the HCI transport manager 182.

During a startup sequence, controller abstractor 170 associates transports 188₁ to 188_{N} to Bluetooth controllers 106₁ to 106_{N}, which may be a homogeneous set of Bluetooth controllers. Controller abstractor 170 may then download firmware to all Bluetooth controllers 106₁ to 106_{N} and assign each Bluetooth controller 106₁ to 106_{N} a unique identifier (ID). Controller abstractor 170 then sends a HCI reset to all Bluetooth controllers 106₁ to 106_{N}. Controller abstractor 170 then starts the clock synchronization service (e.g., 200 of FIG. 2) at the end of the HCI reset command response from all Bluetooth controllers 106₁ to 106_{N}. The clock synchronization service is started by controller abstractor 170 by sending an initiate clock sync command to a primary Bluetooth controller (e.g., having ID 0, such as Bluetooth controller 106₁ of FIG. 3). The primary Bluetooth controller then starts a periodic advertisement with broadcast message to the other Bluetooth controllers with the primary Bluetooth controller's current clock information as previously described and illustrated with reference to FIG. 3.

Controller abstractor 170 includes HCI command listeners. A HCI command/response queue streamlines the command sequence to applicable Bluetooth controllers 106₁ to 106_{N} by processing the next command only after receiving a response for the command. Commands may be applicable to a specific connection, applicable to all Bluetooth controllers 106₁ to 106_{N}, or applicable to a specific Bluetooth controller 106₁ to 106_{N}. For connection handle and Bluetooth Address (BD ADDR) specific commands, controller abstractor 170 routes the command to the corresponding Bluetooth controller based on the mapping captured in the lookup table. For connection, advertising, scan, inquiry, and paging request commands, controller abstractor 170 checks load balancer 174 for an available Bluetooth controller, routes the command to the Bluetooth controller selected by load balancer 174, and updates the lookup table.

For radio frequency (RF) test mode commands, the primary Bluetooth controller may be used for test mode. To test a different Bluetooth controller other than the primary Bluetooth controller, the Bluetooth controller to be tested may be set as the primary Bluetooth controller and the RF test mode commands may then be sent to the primary Bluetooth controller. For a HCI reset command, controller abstractor 170 iterates the command to all Bluetooth controllers 106₁ to 106_{N} and sends one response back to the protocol stack/higher layers 160 for all the Bluetooth controllers. For buffer size commands, controller abstractor 170 iterates the command to all Bluetooth controllers 106₁ to 106_{N}. As each Bluetooth controller 106₁ to 106_{N} may be identical, the buffers available within each Bluetooth controller should be the same. Controller abstractor 170 checks the responses from the buffer size commands from each Bluetooth controller 106₁ to 106_{N} and returns one response to the protocol stack/higher layers 160. If a mismatch is found, controller abstractor 170 sends a hardware error event to the protocol stack/higher layers 160.

For generic configuration commands, controller abstractor 170 iterates the commands to all Bluetooth controllers 106₁ to 106_{N} and sends one response back to the protocol stack/higher layers 160 for all the Bluetooth controllers. As each Bluetooth controller 106₁ to 106_{N} may be identical, the parameters returned from each Bluetooth controller should be the same. Controller abstractor 170 checks the responses from each Bluetooth controller 106₁ to 106_{N} and returns one response to the protocol stack/higher layers 160. If a mismatch is found, controller abstractor 170 sends a hardware error event to the protocol stack/higher layers 160. System 100c may utilize vendor commands for inter-controller communication (e.g., handoff, load status). System 100c may also utilize a vendor command for a paired device list and associated historical data, such as profiles, intervals, etc.

Controller abstractor 170 includes HCI event listeners. For command complete events, controller abstractor 170 uses the command/response queue management to process the response and send the response to protocol stack/higher layers 160. For connection complete/disconnection complete events, controller abstractor 170 updates the lookup table maintaining handle to Bluetooth controller mapping. For other connection events, such as events generated by any other active Bluetooth connections, controller abstractor 170 forwards the event to protocol stack/higher layers 160. For crashdump events, controller abstractor 170 forwards the events to protocol stack/higher layers 160 and hardware (HR) resets all Bluetooth controllers 106₁ to 106_{N}. For hardware error events, controller abstractor 170 forwards the event to protocol stack/higher layers 160.

Controller abstractor 170 includes HCI data path listeners. Controller abstractor 170 adds virtual HCI buffer management for higher layers. Controller abstractor 170 may expose two times the minimum buffer of all Bluetooth controllers 106₁ to 106_{N} as a max buffer to the host. Controller abstractor 170 synchronizes credit management for all data buffers, such as for Asynchronous Connection Less (ACL), Bluetooth Low Energy (BLE), Synchronous Connection Oriented link (SCO)/enhanced SCO (eSCO), and Isochronous Channels (ISoC) buffers. Controller abstractor 170 manages credits internally for all Bluetooth controllers 106₁ to 106_{N} through data queues for each Bluetooth controller. To reduce bottlenecks, data queues are implemented as priority queues prioritizing Human Interface Device (HID) and audio streaming paths. Controller abstractor 170 includes disconnect handling where upon receiving a disconnect event from an external device, controller abstractor 170 drops all packets in the queue for the external device. Upon receiving a disconnect request from the host, controller abstractor 170 adds the request to the HCI command/response queue, and when all queued data packets are sent to the external device, sends the disconnect command to the external device.

Inter-controller communication layer 178 routes certain packets between Bluetooth controllers 106₁ to 106_{N} without going through the protocol stack/higher layers 160. For broadcast packets, inter-controller communication layer 178 may use a custom HCI Payload Type Indicator (HCI PTI) header other than HCI command, event, and data packets. For information exchange with a specific Bluetooth controller, a vendor command may be used. Upon receiving this HCI vender command, the command is routed to the targeted Bluetooth controller. Upon receiving the response for this command, the response is routed to the Bluetooth controller that sent the command.

HCI transport manager 182 routes packets sent to and/or received from the Bluetooth controllers 106₁ to 106_{N}. HCI transport manager 182 handles the HAL layer 186 interfaces for separated controller transports 188₁ to 188_{N}. HCI transport manager 182 routes the packets between protocol stack/higher layers 160 and Bluetooth controllers 106₁ to 106_{N}, which are moderated through controller abstractor 170. HCI command, response, and data queues may be implemented for each Bluetooth Controller 106₁ to 106_{N} in the HCI transport manager 182.

FIG. 11A is a flow diagram illustrating an example method 1100 for controlling the flow of packets between the host 102 and the Bluetooth controllers 106₁ to 106_{N}. Method 1100 may be implemented by controller abstractor 170 and HCI transport manager 182 of multi-controller abstraction layer 150 of FIG. 10. The host 102 may send Logical Link Control and Adaptation Layer Protocol (L2CAP) packets as indicated at 1102, SCO packets as indicated at 1104, and/or Isochronous Adaptation Layer (ISOAL) packets as indicated at 1106. At 1108, the packets 1102, 1104, and/or 1106 are mapped to the corresponding Bluetooth controller (Cx) based on the lookup table and a handle associated with each connection (e.g., via controller abstractor 170). At 1110, the data queue for the corresponding Bluetooth controller is checked to determine whether the data queue is empty. In response to the data queue for the corresponding Bluetooth controller being empty, at 1112 method 1100 determines whether the credits for the corresponding Bluetooth controller are greater than zero. The host (e.g., protocol stack/higher layer 160) will not send new packets until it receives acknowledgment that the previously sent packets have been processed and the Bluetooth controller is ready to receive the new packets. If the credits are greater than zero, the host is notified that new packets may be sent as will be described below with reference to FIG. 11B. In response to the credits being greater than zero, then at 1114 method 1100 sends the packets to the corresponding Bluetooth controller, decrements the credits for the corresponding Bluetooth controller at 1116 and returns at 1120. In response to the data queue for the corresponding Bluetooth controller not being empty at 1110 or in response to the credits not being greater than zero at 1112, then at 1118 method 1100 adds the packets to the data queue for the corresponding Bluetooth controller and returns at 1120. By using credits for each Bluetooth controller, bottlenecks are avoided by preventing one Bluetooth controller from consuming the full bandwidth of the host.

FIG. 11B is a flow diagram illustrating an example method 1150 for controlling the flow of packets between the host 102 and the Bluetooth controllers 106₁ to 106_{N}. Method 1150 may be implemented by controller abstractor 170 and HCI transport manager 182 of multi-controller abstraction layer 150 of FIG. 10. At 1152, a number complete indicating an acknowledgment of the number of processed packets by the corresponding Bluetooth controller is received. In response to the number complete, at 1154 method 1150 increments the credits for the corresponding Bluetooth controller. At 1156, method 1150 sends the number complete to the host (e.g., acknowledgment to protocol stack/higher layers 160 that the previously sent packets have been processed and the Bluetooth controller is ready to receive new packets). At 1158, method 1150 determines whether the data queue for the corresponding Bluetooth controller is empty. If the data queue is not empty, then at 1160 method 1150 pops the data queue and sends the packets to the corresponding Bluetooth controller. At 1162, method 1150 decrements the credits for the corresponding Bluetooth controller and returns at 1164. In response to the data queue for the corresponding Bluetooth controller being empty at 1158, method 1150 returns at 1164.

FIG. 12 is a flow diagram illustrating an example method 1200 for load balancing. Load balancing may be based on a feedback system 1206. Feedback system 1206 provides historical information about the connected devices. The information may be gathered from different modules in the system. The feedback system reduces the live handoff process for many scenarios. Bluetooth devices tend to use static profiles and connect in peripheral roles (e.g., gaming controller, headphones, remote, etc.). The type of connection and profile used by the device may be provided by protocol stack/higher layers 160 (FIG. 10) (e.g., audio streaming, HID (Sniff/LE), sensor nodes, etc.). Bandwidth used by the devices in the past may be provided by the load balancer based on the state of the system when the device was previously connected. For example, bandwidth levels for HID/remote (e.g., LE connection interval or Sniff interval and throughput levels, packet size), classic BR/EDR audio (e.g., A2DP streaming, eSCO/SCO based call control or voice chat, etc.), LE audio (e.g., broadcast audio, unicast audio), etc. may be determined by the load balancer.

The protocol stack/higher layers 160 sends historical data to the feedback system 1206 as indicated at 1204. Each Bluetooth controller 106₁ to 106_{N} sends its current state (e.g., number of connections, current load, etc.) to load balancer 1210 as indicated at 1216. Load balancer 1210 sends the system state to feedback system 1206 as indicated at 1212. Based on the historical data and the system state, feedback system 1206 sends feedback data to load balancer 1210 as indicated at 1208. Load balancer 1210 then uses the feedback data to manage the load (e.g., including initiating handoffs if needed) among the Bluetooth controllers 106₁ to 106_{N} as indicated at 1214. By having more information available about a device from the historical data, an optimal scheduling policy can be achieved statically even before the system gets into a connected state. In some examples, scenarios may be simulated in a test environment to create strategies for managing different combinations of devices prior to deployment of the system.

In some examples, host 102 may include a processing system to perform the host operations and methods described with reference to FIGS. 1A-12. The processing system may include a processor and a machine-readable storage medium. The processor may be communicatively coupled to the machine-readable storage medium through a communication path. Although the following description refers to a single processor and a single machine-readable storage medium, the description may also apply to a system with multiple processors and multiple machine-readable storage mediums. In such examples, the data and instructions may be distributed (e.g., stored) across multiple machine-readable storage mediums and the instructions may be distributed (e.g., executed by) across multiple processors.

The processor may include one (i.e., a single) central processing unit (CPU) or microprocessor or more than one (i.e., multiple) CPU or microprocessor, and/or other suitable hardware devices for retrieval and execution of instructions stored in the machine-readable storage medium. The processor may fetch, decode, and execute instructions to implement the functions and methods described with reference to FIGS. 1A-12.

As an alternative or in addition to retrieving and executing instructions, the processor may include one (i.e., a single) electronic circuit or more than one (i.e., multiple) electronic circuit comprising a number of electronic components for performing the functionality of one of the instructions or more than one of the instructions of the machine-readable storage medium. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

The machine-readable storage medium is a non-transitory storage medium and may be any suitable electronic, magnetic, optical, or other physical storage device that stores executable instructions. Thus, the machine-readable storage medium may be, for example, a random access memory (RAM), an electrically-erasable programmable read-only memory (EEPROM), a storage drive, an optical disc, and the like. The machine-readable storage medium may be disposed within host 102. In this case, the executable instructions may be installed on the host 102. Alternatively, the machine-readable storage medium may be a portable, external, or remote storage medium that allows the host 102 to download the instructions from the portable/external/remote storage medium. In this case, the executable instructions may be part of an installation package.

Likewise, in some examples, each Bluetooth controller 106₁ to 106_{N} may include a processing system to perform the Bluetooth controller operations and methods described with reference to FIGS. 1A-12. The processing system for each Bluetooth controller 106₁ to 106_{N} may include a processor and a machine-readable storage medium. The processor may include one (i.e., a single) CPU or microprocessor or more than one (i.e., multiple) CPU or microprocessor, and/or other suitable hardware devices for retrieval and execution of instructions stored in the machine-readable storage medium.

It is to be understood that the features of the various example embodiments described herein may be combined with each other, unless specifically noted otherwise.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A system comprising:
a host configured to execute a Bluetooth protocol stack; and
at least two Bluetooth controllers communicatively coupled to the host, each Bluetooth controller configured to wirelessly communicate with at least one respective external device.

2. The system of claim 1, wherein the host comprises a multi-controller abstraction layer configured to present the at least two Bluetooth controllers to the Bluetooth protocol stack as a single Bluetooth controller.

3. The system of claim 2, wherein the multi-controller abstraction layer comprises an inter-controller communication layer configured to pass messages between the at least two Bluetooth controllers.

4. The system of claim 2, wherein the multi-controller abstraction layer comprises a host controller interface transport manager configured to pass packets between the multi-controller abstraction layer and the at least two Bluetooth controllers.

5. The system of claim 2, wherein the multi-controller abstraction layer comprises a controller abstractor configured to map active Bluetooth operations between the Bluetooth protocol stack and the at least two Bluetooth controllers.

6. The system of claim 2, wherein the multi-controller abstraction layer comprises a load balancer configured to place or transfer external device connections among the at least two Bluetooth controllers to manage bandwidth of each of the at least two Bluetooth controllers.

7. The system of claim 2, wherein the host comprises a hardware abstraction layer between the multi-controller abstraction layer and the at least two Bluetooth controllers.

8. A system comprising:
a host configured to execute an application and a Bluetooth protocol stack, the host comprising a multi-controller abstraction layer; and
a plurality of Bluetooth controllers communicatively coupled to the host, each Bluetooth controller configured to wirelessly communicate with at least one respective external device,
wherein the multi-controller abstraction layer is configured to present the plurality of Bluetooth controllers to the Bluetooth protocol stack as a single Bluetooth controller.

9. The system of claim 8, wherein each of the plurality of Bluetooth controllers comprises a same Bluetooth address to communicate with external devices.

10. The system of claim 8, wherein the host and the plurality of Bluetooth controllers are integrated into a single semiconductor chip.

11. The system of claim 8, wherein the host and the plurality of Bluetooth controllers are integrated into different semiconductor chips.

12. The system of claim 8, wherein the multi-controller abstraction layer comprises a load balancer to share an active load of the system among the plurality of Bluetooth controllers.

13. The system of claim 12, wherein the multi-controller abstraction layer comprises a feedback system based on historical data to optimize handoff and load balancing among the plurality of Bluetooth controllers.

14. The system of claim 8, wherein each of the plurality of Bluetooth controllers comprises:
a clock; and
a clock synchronization service to synchronize the clocks of the plurality of Bluetooth controllers with each other.

15. The system of claim 8, wherein each of the plurality of Bluetooth controllers comprises a connection handoff service to transfer connections between the plurality of Bluetooth controllers.

16. The system of claim 8, wherein each of the plurality of Bluetooth controllers comprises a load balancing service to track runtime loading of the corresponding Bluetooth controller.

17. A method comprising:
receiving a request to connect an external device to a Bluetooth system comprising a host executing a Bluetooth protocol stack; and
connecting the external device to a first Bluetooth controller of a plurality of Bluetooth controllers communicatively coupled to the host based on an expected bandwidth level for the external device.

18. The method of claim 17, further comprising:
handing off the connection of the external device from the first Bluetooth controller to a second Bluetooth controller of the plurality of Bluetooth controllers.

19. The method of claim 17, further comprising:
synchronizing a clock of the first Bluetooth controller with a clock of each of the plurality of Bluetooth controllers.

20. The method of claim 17, further comprising:
controlling a flow of packets between the Bluetooth protocol stack and each of the plurality of Bluetooth controllers to meet a target quality of service level.
